(19) United States
(12) Patent Application Publication
(10) Pub. No.: US 2014/0101688 A1
(43) Pub. Date: Apr. 10, 2014

(54) WATCHING PROGRAM INFORMATION COLLECTING METHOD AND SYSTEM

(71) Applicant: COTTON INTERACTIVE CO., LTD., Seoul (KR)

(72) Inventor: Chang Hwan KIM, Gyeonggi-do (KR)

(73) Assignee: COTTON INTERACTIVE CO., LTD., Seoul (KR)

(21) Appl. No.: 13/725,097

(22) Filed: Dec. 21, 2012

(30) Foreign Application Priority Data
Oct. 8, 2012 (KR) 10-2012-0111445

(51) Int. Cl. H04N 21/24

(52) U.S. Cl. CPC H04N 21/24
USPC 725/18

(57) ABSTRACT

Provided are a method and system for collecting information regarding a program being currently watched by a user of a cell phone in connection with an application installed in the cell phone and a TV. Provided are a method and system for comparing in real time audio data received from the cell phone with a sound signal received from a broadcasting station to collect and utilize information about the program being currently watched.

### CROSS-REFERENCE TO RELATED APPLICATIONS

This application claims priority under 35 U.S.C. §119 to Korean Patent Application No. 10-2012-0111445, filed on Oct. 8, 2012, the disclosure of which is incorporated herein by reference in its entirety.

### TECHNICAL FIELD

The present disclosure relates to a method and system for collecting information regarding a program being watched by a user, and in particular, to watching program information collecting method and system for controlling a TV with a cell phone while a holder of the cell phone is watching a TV program, acquiring information regarding the program through the cell phone, and transmitting the program information to the cell phone.

### BACKGROUND

Introduction of smart TVs enables users to enjoy two-way service based on the Internet, in addition to watch TV programs. However, a TV screen may be partially occupied to access the Internet service while watching TV. Unfortunately, this makes a problem in watching TV. For solving this problem, a service in connection with a general TV and a smart phone begins to be provided.

This is to provide the service in connection with the TV through an application running on a mobile device such as the smart phone, which supports that a user can check in a TV program the user is currently watching, searching for relevant content, and sharing the relevant content via a variety of SNS. Users may acquire a variety of information regarding a TV program, such as a broadcasting channel, broadcasting number, broadcasting time, relevant link, etc., through the application.

Moreover, the users may acquire information about new programs and exchanges opinions on favorite programs with their friends.

However, the related art applications have difficulties in that a database should be built to contain the audio files and the audio signals cannot be compared in real time with the audio files because the audio signals are compared with the audio data stored in the database when the audio signals are matched in order to acquire the program information.

### SUMMARY

Accordingly, the present disclosure provides a method and system for collecting information about a program currently watched by a holder of the cell phone without an audio file DB, by comparing sound signals broadcast from a broadcasting station with TV audio data received from a cell phone to identify the program information.

The present disclosure also provides a method and system for finding tendency of viewers on the basis of the collected program information, utilizing the tendency as data used in broadcasting production, and providing an advertisement, event, and so on appropriate for each viewer.

In one general aspect, a watching program information collecting method includes: receiving position information and audio data of a TV program currently watched by a user of a cell phone, from the cell phone; receiving in real time a sound signal currently broadcast from a broadcasting station; identifying a region where the user of the cell phone is watching TV, on the basis of the position information; comparing a sound signal currently broadcast in the region with the audio data to identify information about the TV program; generating a message about an advertisement, event, or survey to be provided to the user on the basis of the information about the program currently watched by the user of the cell phone; and transmitting the generated message to the cell phone.

The identifying of information about the TV program may include: analyzing a matching rate between the audio data and the sound signal; identifying a TV channel broadcasting a sound signal having a highest matching rate; and identifying information about TV program currently broadcast in the TV channel, from a broadcast programming list.

In another general aspect, a watching program information collecting system includes: a remote control converter converting a TV control signal received from a cell phone having an installed remote control application for wirelessly controlling a TV and transmitting the signal to the TV; and a watching program analysis server receiving position information and audio data of a TV program currently watched by a user of the cell phone, from the cell phone; identifying a region where the user of the cell phone is watching TV, on the basis of the position information; receiving a sound signal currently broadcast in the region; and comparing the audio data with the broadcast sound signal to identify information about the program currently watched by the user.

In still another general aspect, a watching program analysis server includes: a receiver receiving position information and audio data of a currently watched TV program from a cell phone where a remote control application is running; at least one tuner receiving a sound signal currently broadcast from a broadcasting station; and a controller identifying a region where a user of the cell phone is watching TV, on the basis of the position information, comparing the sound signal currently broadcast in the region with the audio data to identify information about a TV channel watched by the user, and identifying information about the program currently watched by the user from the channel information and a broadcast programming list.

Other features and aspects will be apparent from the following detailed description, the drawings, and the claims.

### BRIEF DESCRIPTION OF THE DRAWINGS

FIG. 1 is a block diagram illustrating structures of a watching program information collection system and a watching program analysis server according to an embodiment of the present invention.

FIG. 2 is a flow chart illustrating a method of collecting the watching program information according to an embodiment of the present invention.

### DETAILED DESCRIPTION OF EMBODIMENTS

The advantages, features and aspects of the present invention will become apparent from the following description of the embodiments with reference to the accompanying drawings, which is set forth hereinafter. The present invention may, however, be embodied in different forms and should not be construed as limited to the embodiments set forth herein. Rather, these embodiments are provided so that this disclosure will be thorough and complete, and will fully convey the scope of the present invention to those skilled in the art.

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Hereinafter, embodiments of the present invention will be described in detail with reference to the accompanying drawings.

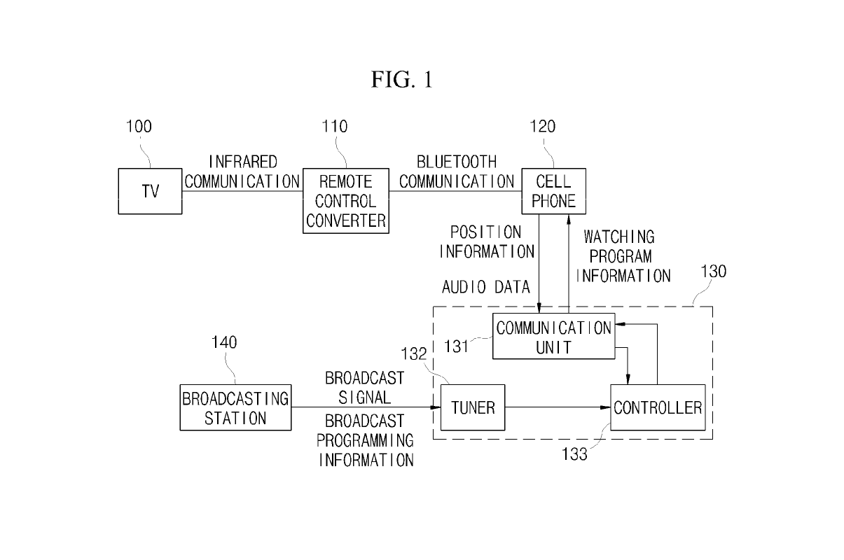

FIG. 1 is a block diagram illustrating structures of a watching program information collection system and a server for analyzing a watching program according to an embodiment of the present invention.

The watching program information collection system according to an embodiment of the present invention includes a remote control converter 110 and a watching program analysis server 130.

The remote control converter 110 receives a signal from a cell phone 120 and delivers the signal to a TV 100 when a user powers the TV on or off or changes a TV channel or volume through an application installed in the cell phone 120. The remote control converter 110 may communicate with the TV 100 and the cell phone 120 in various ways. The remote control converter 110 mainly receives a signal from the cell phone 120 through Bluetooth communication, changes the received signal into an infrared signal, and then transmits the infrared signal to the TV 100.

If the TV has a USB port, the remote control converter 110 may access the USB port to deliver the signal from the cell phone.

The remote control converter 110 may deliver the signal received from the cell phone 120, to the TV 100, to allow the user of the cell phone 120 to control the TV 100 with the cell phone 120.

Also, the remote control converter 110 receives audio data output from the TV 100 and then delivers the audio data to the cell phone 120. The cell phone 120 may receive the audio data output from the TV 100, using a microphone of the cell phone 120.

The cell phone 120 receives audio data about a currently watched TV program from the TV 100 or the remote control converter 110 and transmits the audio data to the watching program analysis server. The cell phone 120 transmits current position information of the cell phone 120 while transmitting the audio data.

The cell phone 120 may transmit position information and audio data in real time or periodically at predetermined intervals. Alternatively, when the change of TV channel by the user is sensed through the application installed in the cell phone 120 or a predetermined time has elapsed after the change in TV channel (for example, after 5 or 10 seconds has elapsed because transmitting in real time the audio data is meaningless in program information acquisition when continuing to change channels to find a desired channel), the cell phone 120 may transmit position information and audio data in real time or periodically at predetermined intervals.

The watching program analysis server 130 collects information about a TV program being currently watched by the user of the cell phone 120, using position information and audio data received from the cell phone of the user who is watching the TV 100.

The watching program analysis server 103 includes a communication unit 131, a tuner 132, and a controller 133.

The communication unit 131 receives the position information and audio data from the cell phone 120 and delivers the received information and data to the controller 133.

The tuner 132 receives a sound signal being broadcast by a broadcasting station and delivers the received sound signal to the controller 133. The tuner 132 may continue to receive a signal being broadcast by a broadcasting station or may receive the signal only when the tuner 132 receives a reception command from the controller 133. Also, it is desirable that the number of tuners 132 is the same as that of broadcast signals of the broadcasting station.

The controller 133 identifies a region where the user of the cell phone 120 is watching the TV from the position information about the cell phone 120, which is received through the communication unit 131. This is for considering a TV watching region in acquisition of program information because TV broadcasting programs are programmed differently depending on regions.

The controller 133 identifies the region where the user is watching the TV and acquires broadcast programming information provided by the broadcasting station 140 and a sound signal broadcast in a corresponding region. Alternatively, the controller 133 may identify the signal broadcast in the corresponding region from among broadcast signals continuously received by the tuner 132, and receive the signal.

The controller 133 compares audio data received from cell phone 120 with a sound signal broadcast in the region where the user of the cell phone 120 is watching TV, and checks whether or not the audio data is matched with the sound signal. The controller 133 identifies the TV channel broadcasting the sound signal, which are matched with the audio data or have the highest matching rate through a matching analysis, from among channels received by the tuner in the corresponding region.

That is, the present invention compares the audio data transmitted from the cell phone with a broadcast audio signal currently broadcast in a TV channel that can be watched in a position where the cell phone is located, instead of direct comparison with TV program, to identify the TV channel being watched.

For example, if a sport is broadcast in channel A, a news is broadcast in channel B, and a soap opera is broadcast in channel C, a TV channel currently watched by the user of the cell phone can be estimated with high precision using a matching algorithm having low complexity because difference between audio signals of the channels is significantly great. That is, it is possible to estimate the TV channel with high reliability even while the matching algorithm is operated with high speed by low performance H/W.

The controller 133 identifies the TV channel being watched by the user of the cell phone 120, and then identifies a program broadcast in a position of the cell phone through a corresponding channel at a current time using a collected broadcast programming table. The controller 133 transmits the identified program information to the cell phone 120 through the communication unit 131.

That is, the present invention identifies a channel without comparison between audio data from a cell phone and audio data for a program and then identifies the program using a TV programming table, thereby having no need to build in advance a DB for audio data of programs to be compared and estimating the currently watched program with high reliability in real time matching.

The controller 133 may provide information service suitable for the user of cell phone 120 on the basis of the identified watching program information, time, position information, etc. For example, a SNS bulletin board for each program may be provided. An event for giving economic benefits to the user may be provided through an application. Alternatively, informative advertisement may be provided to a main target group.

A woman in 20's having interest in music may be provided with a musical ticket after any survey. A man in 30's enjoying a Korean TV program entitled “one night journey” may be provided with an event for travel product discount. A man in 40's frequently watching news may be provided with a survey for favorite political party. Information about age, sex, etc. may be found out through setup information of an application of the cell phone. The participation of users may be encouraged by giving mobile gift card or movie ticket to users who participate in the event or survey.

The watching program information may be utilized by the broadcasting station 140. The broadcasting station 140 may receive the watching program information about users, which is collected by the watching program analysis server 130, to utilize the information in aggregation of viewer ratings, or may receive opinions of the users to allow the users to directly affect broadcasting production.

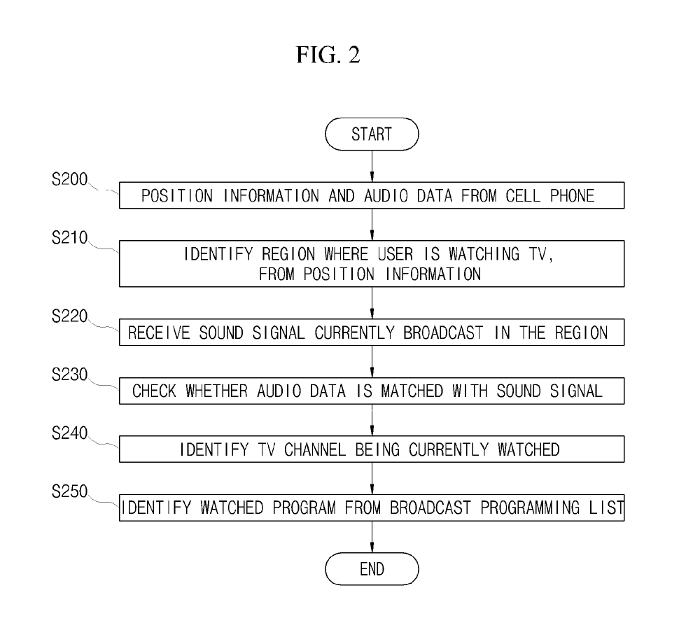

FIG. 2 is a flow chart illustrating a method of collecting the watching program information according to an embodiment of the present invention.

In operation S200, a watching program analysis server receives audio data of a program being watched by a user of a cell phone having an installed TV control application and position information about the user from the cell phone.

The watching program analysis server identifies a region where the user of the cell phone is watching TV, using the received position information in operation S210, and requests and receives a currently broadcast sound signal from a broadcasting station in the region in operation S220. Alternatively, the watching program analysis server may continue to receive the sound signal, and when receiving the position information, identify sound signal being broadcast in the region.

In operation S230, the watching program analysis server compares the sound signal received from the broadcasting station with audio data received from the cell phone and then checks whether or not the sound signal is matched with the audio data. The matching between the sound signal and the audio data is performed by comparing matching rates of sound signals to select a sound signal having a highest matching rate.

In operation S240, the watching program analysis server may identify a TV channel broadcasting the selected sound signal to estimate a TV channel being watched by the user of the cell phone. For example, if audio matching rates are 20% of Korean Broadcasting System (KBS), 50% of Munhwa Broadcasting Corporation (MBC), and 80% of Seoul Broadcasting System (SBS) as a result of comparison sound signals broadcast from KBS, MBC, and SBS in Busan, which is a second largest city of South Korea, the user of the cell phone is identified as watching SBS.

In operation S250, the watching program analysis server may identify the program that is currently watched by the user of the cell phone from a broadcast programming list for the region, in consideration of the channel which is currently watched by the user and the region where the user is currently watching the channel.

The present invention can compare the TV audio data received from the cell phone with the sound signal received by the tuner from the broadcasting station to collect and utilize in real time information regarding the program currently watched by the user of the cell phone.

The above-disclosed subject matter is to be considered illustrative, and not restrictive, and the appended claims are intended to cover all such modifications, enhancements, and other embodiments, which fall within the true spirit and scope of the present invention. Accordingly, embodiments of the present invention are intended not to limit, but to explain the technical spirit of the present invention. The scope of the present invention is not limited by these embodiments. The scope of the invention should be construed in accordance with the following claims, and all technical ideas should be construed as covering all the modifications, equivalents, and replacements within the scope of the present invention.

A number of exemplary embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A watching program information collecting method, comprising:
receiving position information and audio data of a TV program currently watched by a user of a cell phone from the cell phone;
receiving in real time a sound signal currently broadcast from a broadcasting station;
identifying a region where the user of the cell phone is watching TV, on the basis of the position information; and
comparing a sound signal currently broadcast in the region with the audio data to identify information about the TV program.

2. The watching program information collecting method of claim 1, wherein the identifying of information about the TV program comprises:
analyzing a matching rate between the audio data and the sound signal;
identifying a TV channel broadcasting a sound signal having a highest matching rate; and
identifying information about TV program currently broadcast in the TV channel, from a broadcast programming list.

3. The watching program information collecting method of claim 1, wherein the receiving of position information and audio data of a TV program currently watched by a user of a cell phone from the cell phone is performed whenever the user of the cell phone changes TV channels with a remote control application installed in the cell phone.

4. The watching program information collecting method of claim 1, wherein the receiving of position information and audio data of a TV program currently watched by a user of a cell phone from the cell phone is performed at certain intervals while a remote control application installed in the cell phone is running.

5. The watching program information collecting method of claim 1, wherein the receiving in real time of a sound signal currently broadcast from a broadcasting station is performed by receiving sound signals locally broadcast from several broadcasting stations using a TV tuner.

6. The watching program information collecting method of claim 1, further comprising:
generating a message about an advertisement, event, or survey to be provided to the user on the basis of the information about the program currently watched by the user of the cell phone; and
transmitting the generated message to the cell phone.

7. The watching program information collecting method of claim 1, further comprising transmitting the information about the program currently watched by the user of the cell phone to the cell phone.

8. A watching program information collecting system, comprising:
a remote control converter converting a TV control signal received from a cell phone having an installed remote control application for wirelessly controlling a TV and transmitting the signal to the TV; and
a watching program analysis server receiving position information and audio data of a TV program currently watched by a user of the cell phone from the cell phone and comparing the audio data with a sound signal currently broadcast in a region where the cell phone is located to identify information about the program currently watched by the user.

9. The watching program information collecting system of claim 8, wherein the watching program analysis server analyzes a matching rate between the audio data and the sound signal, identifies a TV channel having a highest matching rate, and estimating the TV program broadcast through the TV channel, using a channel programming list.

10. The watching program information collecting system of claim 8, wherein the watching program analysis server generates a message about an advertisement, event, or survey to be provided to the user on the basis of the information about the program currently watched by the user; and transmits the message to the cell phone of the user.

11. The watching program information collecting system of claim 8, wherein the cell phone transmits the position information and the audio data of the program currently watched by the user of the cell phone whenever the user changes TV channels with the remote control application.

12. The watching program information collecting system of claim 8, wherein the cell phone transmits the position information and the audio data of the program currently watched by the user of the cell phone at certain intervals while the remote control application is running on the cell phone.

13. The watching program information collecting system of claim 8, wherein the remote control converter communicates with the cell phone via Bluetooth, receives a signal from the cell phone, and transmits the signal to the TV.

14. A watching program analysis server, comprising:
a receiver receiving position information and audio data of a currently watched TV program from a cell phone where a remote control application is running;
at least one tuner receiving a sound signal currently broadcast from a broadcasting station; and
a controller identifying a region where a user of the cell phone is watching TV, on the basis of the position information, comparing the sound signal currently broadcast in the region with the audio data to identify information about a TV channel watched by the user, and identifying information about the program currently watched by the user from the channel information and a broadcast programming list.

15. The watching program analysis server of claim 14, wherein the controller generates a message about an advertisement, event, or survey on the basis of the information about the program currently watched by the user of the cell phone, and transmits the generated message to the cell phone.
